(19) United States
(12) Patent Application Publication
(10) Pub. No.: US 2008/0312059 A1
(43) Pub. Date: Dec. 18, 2008

(54) Folding apparatus

(75) Inventors: Antonious J.J. Van Gerven, Grubbenvorst (NL); Floris J. Marcelis, Venlo (NL); Michiel A.C. Terhaag, Melick (NL); Paul G. Van Veen, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B. V.

(21) Appl. No.: 12/213,056

(22) Filed: Jun. 13, 2008

(30) Foreign Application Priority Data
Jun. 15, 2007 (EP) 07110399.8

(51) Int. Cl. B31F 1/10

(52) U.S. Cl. 493/442

(57) ABSTRACT

A folding apparatus includes a feed unit for supplying a medium to be folded, a folding substrate forming a convexly curved support surface for the medium and adapted to be driven back and forth in a circumferential direction of the curved support surface, and a pinch and guide structure for folding and guiding the medium on the support surface. The pinch and guide structure includes at least one endless belt that is arranged to have a belt portion held in mating engagement with a portion of the curved support surface.

### CROSS-REFERENCE TO RELATED APPLICATIONS

This application claims priority under 35 U.S.C. §119(a) to Application No. 07110399.89, filed in Europe on Jun. 15, 200, the entirety of which is expressly incorporated herein by reference.

### BACKGROUND OF THE INVENTION

1. Field of the Invention

The present invention relates to a folding apparatus that includes a feed unit for supplying a medium to be folded, a folding substrate forming a convexly curved support surface for the medium and adapted to be driven back and forth in a circumferential direction of the support surface, and a pinch and guide structure for folding and guiding the medium on the support surface, wherein the pinch and guide structure includes two endless belts each of which is arranged to have a belt portion held in mating engagement with a portion of the curved support surface, so that the two endless belts define two separate paths for the medium.

2. Description of Background Art

A folding apparatus of this type has been disclosed in EP 0 717 486 A1. A similar apparatus is described in EP 05 90 359 A1.

### SUMMARY OF THE INVENTION

It is an object of the present invention to provide a folding apparatus of the type indicated above which has a simple construction and an improved operational flexibility.

In order to achieve this object, according to the present invention, the folding substrate and the pinch and guide structure define a closed circulation path, in which the two separate paths are joined at a point remote from the feed unit.

The portion of the belt held in mating engagement with the support surface will smoothly and reliably guide the medium along the support surface. Since the belt portion may easily be deflected in the direction away from the support surface, the pinch and guide structure may easily adapt to media with varying thicknesses and configurations. Thus, the folding apparatus according to the present invention is particularly useful for forming crossfolds in media that have been fan-folded into a multi-layer structure in a preceding folding station.

Moreover, the endless belt may be driven so as to move with a speed that is essentially identical with the speed of the surface of the folding substrate, so that the sheet may be conveyed without any substantial friction and, consequently, reduced risk of shear strain and damage.

Since the two separate paths are joined at a point remote from the feed unit, it is possible to accommodate larger media.

The folding substrate may be a drum or an endless belt, so that the medium that is being processed may be caused to revolve in the apparatus. In this way, by suitably controlling a discharge gate that is disposed at the periphery of the endless folding substrate, it is possible to discharge a folded sheet in either of two orientations, so that, if the medium to be folded is a design drawing, for example, the legend of the drawing may always be placed in the right position.

A pinch roller may be provided for pressing the belt against the support surface of the substrate at the position where the fold is to be formed. This pinch roller may at the same time serve as a deflection roller for deflecting the endless belt or may be provided in addition to a set of deflection rollers and arranged at an intermediate portion of the belt that is in mating engagement with the support surface.

Preferably, the pinch and guide structure comprises a pair of endless belts and associated deflection rollers and/or pinch rollers arranged symmetrically with respect to the feed unit. This provides a high flexibility in forming different folding patterns, including zig-zag folds and C-folds.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic overall view of a folding apparatus according to one embodiment of the present invention;

FIG. 2 is a schematic cross-sectional view taken along the line II-II in FIG. 1;

FIG. 3 is a schematic perspective view illustrating the function principle of the folding apparatus;

FIGS. 4-7 are simplified schematic views similar to FIG. 1, illustrating different stages in a first mode of operation of the apparatus;

FIGS. 8 and 9 are views illustrating a second mode of operation;

FIGS. 10-16 are views illustrating a third mode of operation;

FIG. 17 is a schematic overall view of a folding apparatus according to another embodiment of the present invention; and

FIG. 18 is a schematic overall view of a folding apparatus according to yet another embodiment of the present invention.

### DETAILED DESCRIPTION OF THE PREFERRED EMBODIMENTS

The present invention will now be described with reference to the accompanying drawings, wherein the same reference numerals have been used to identify the same or similar elements throughout the several views.

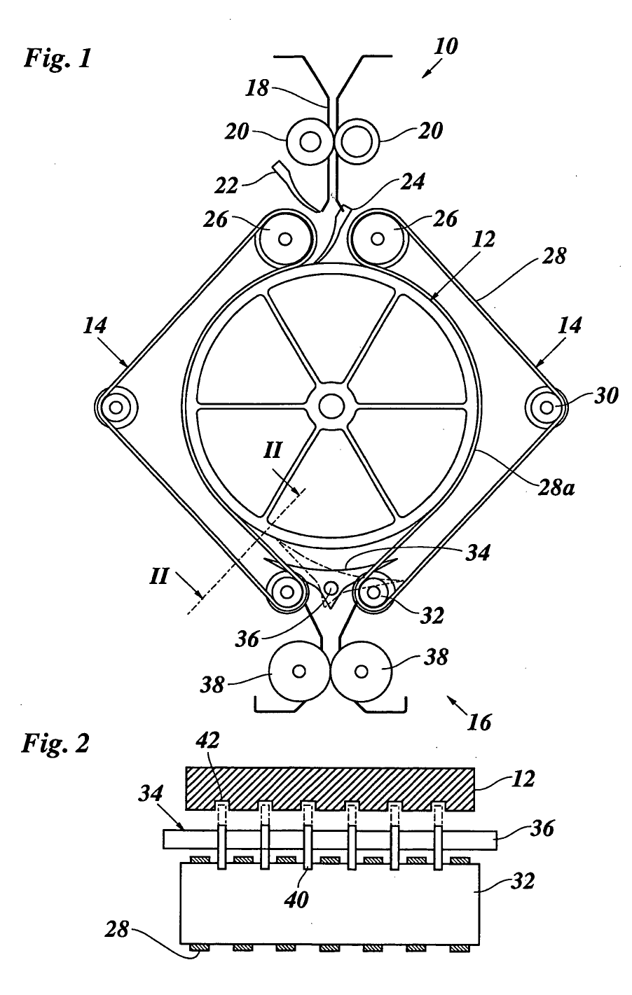

As is shown in FIG. 1, a folding apparatus comprises a feed unit 10, a folding substrate which, in this embodiment, is configured as a cylindrical drum 12, and a pair of pinch and guide structures 14 that are arranged symmetrically with respect to the feed unit 10 at the peripheral surface of the drum 12. A discharge unit 16 is arranged in a position diametrically opposite to the feed unit 10.

The feed unit 10 comprises a guide channel 18 arranged for guiding sheet-like media (not shown in FIG. 1), e.g. print media such as paper or the like, vertically downward onto the peripheral surface of the drum 12. A pair of feed rollers 20 form a nip in the supply channel 18. At least one of the feed rollers 20 is driven, so as to control the supply of the sheets to the drum 12.

Two deflection fingers 22 and 24 are arranged at the downstream end of the feed unit 12 for deflecting the sheets at the transit point between the feed unit 10 and the surface of the drum 12. The deflection fingers 22, 24 are adjustable by means of a set mechanism that has not been shown, so that they may optionally be brought into an operative position. In the example shown in FIG. 1, the deflection finger 24 is in the operative position.

Each pinch and guide structure 14 comprises a pinch roller 26 and an endless belt 28 or rather an array of several parallel belts that are trained around the pinch roller 26 and two deflection rollers 30 and 32. The pinch roller 26 and the deflection rollers 30, 32 are arranged such that a portion 28a of the belt 28 is held in mating engagement with the peripheral surface of the drum 12. In the example shown, the portion 28a extends over an angle of almost 180° from the feed unit 10 to the discharge unit 16. The belt 28 may be elastic, or one of the deflection rollers, e.g., the roller 30, may be supported elastically so as to hold the belt 28 under appropriate tension, so that the portion 28a will suitably be pressed against the surface of the drum 12.

The drum 12 is connected to a drive mechanism (not shown) so as to be rotatable in either direction about its central axis. The belts 28 and the pinch rollers and deflection rollers may be driven through frictional contact with the peripheral surface of the drum 12. Preferably, however, one of the pinch rollers 26 and deflection rollers 30, 32 of each pinch and guide structure 14 is driven actively by means of a drive mechanism (not shown).

The discharge unit 16 comprises a discharge gate 34 that is disposed between the two deflection rollers 32 and is pivotable about an axis 36. Further, a pair of discharge rollers 38 form a transport nip below the deflection rollers 32.

FIG. 2 shows a cross section of a portion of the peripheral wall of the drum 12 as well as cross sections of the plurality of belts 28 that are trained around the deflection roller 32. The discharge gate 34 has a comb-structure with a plurality of fingers 40 arranged in the intervals between the individual belts 28. In the condition that has been shown in solid lines in FIGS. 1 and 2, the fingers 20 project into the gaps between the belts 28, whereas, when the gate is pivoted about the axis 36 into the position that has been shown in phantom lines in FIGS. 1 and 2, the fingers 40 project into grooves 42 that are formed in the peripheral surface of the drum 12.

Thus, when the gate 34 is in the position shown in phantom lines, a sheet that is conveyed downwardly between the surface of the drum 12 and the belts 28 on the left side of the drum will be separated from the drum surface by the fingers 40 and guided into the nip of the discharge rollers 38 so as to be discharged from the apparatus. On the other hand, when the gate 34 is in the position shown in solid lines, the leading edge of a sheet that is paid out between the belts 28 and the drum surface will be deflected into the narrowing gap between the drum surface and the belts 28 of the other pinch and guide structure 14 (on the right side in FIG. 1), so that the sheet will be caught again between the drum and the belts 28 and continue to revolve about the axis of the drum 12.

It will be clear that the gate 34 may also be pivoted into a position mirror-symmetrical to the one shown in phantom lines in FIG. 1, so as to discharge sheets when the drum 12 rotates in an opposite direction.

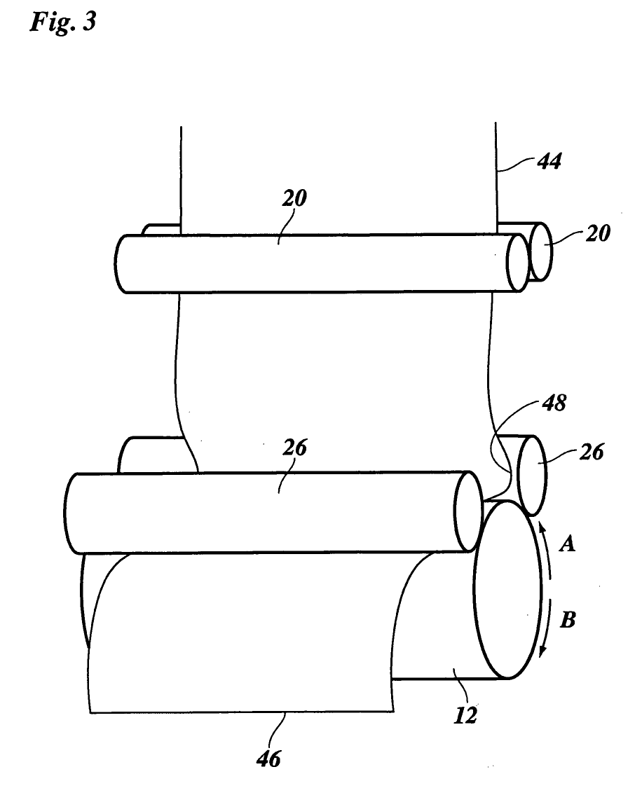

The function principle of the folding apparatus will now be explained in conjunction with FIG. 3. A sheet 44, e.g. of a recording medium exiting from a printer, is supplied by means of the feed rollers 20 towards the drum 12. When the leading edge 46 of the sheet 44 reaches the surface of the drum 12 and the drum is driven in the direction indicated by an arrow A, the sheet is deflected into the nip between the drum 12 and the front pinch roller 26 in FIG. 3. The deflection finger 24 (FIG. 1) may be brought into its operating position in order to assist in this deflection. Then, when a certain length of the sheet 44 has been fed through the nip, as shown in FIG. 3, the direction of rotation of the drum 12 is reversed (direction B), while the feed rollers 20 continue to feed the trailing part of the sheet 44 downwardly or at least are held stationary so as to prevent the sheet 44 from being pushed upward again. As a consequence, the sheet 44 forms a blouse 48 that bulges towards the rear pinch roller 26 in FIG. 3. When this blouse is caught between the pinch roller and the surface of the drum 12, it is drawn into the nip between these two members, so that a fold is formed in the sheet.

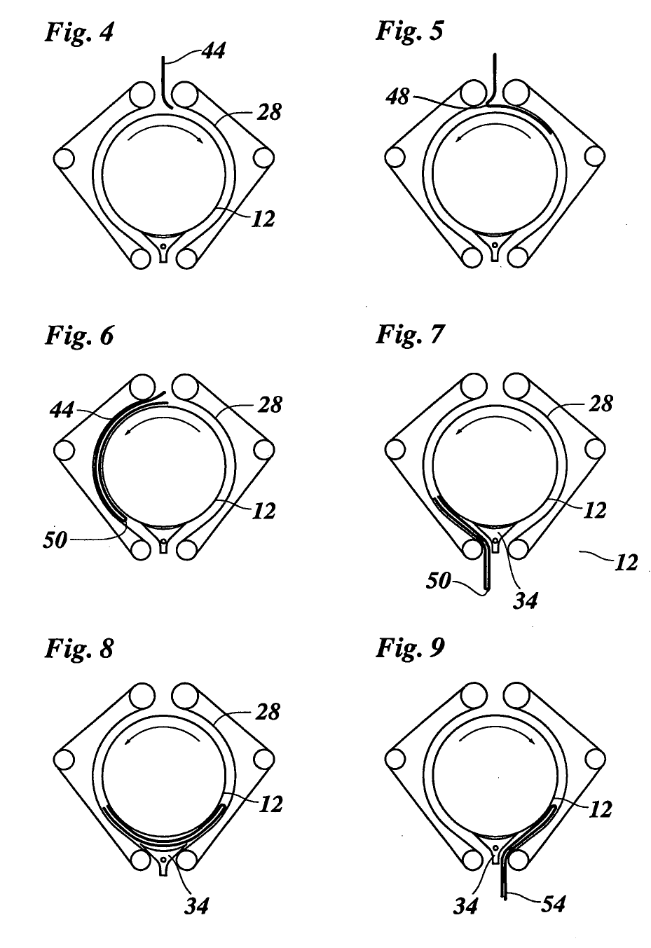

This process is illustrated further in FIGS. 4 to 7 which show a mode of operation in which a single fold is formed in the sheet and the sheet is then discharged with the fold ahead.

In FIG. 4, the drum 12 is rotated clock-wise, and the sheet 44 is fed downwardly and deflected into the gap formed between the surface of the drum 12 and the belt 28. When a certain length of the sheet 44 has been drawn in, the direction of rotation of the drum 12 is reversed, as shown in FIG. 5, so as to form the blouse 48.

When the drum 12 is rotated further in counter clock-wise direction, as in FIG. 6, the blouse is pinched between the drum 12 and the pinch roller and the belt 28, respectively, and a fold 50 is formed. Then, as shown in FIG. 7, the fold 50 reaches the gate 34 and is deflected from the surface of the drum 12 and discharged.

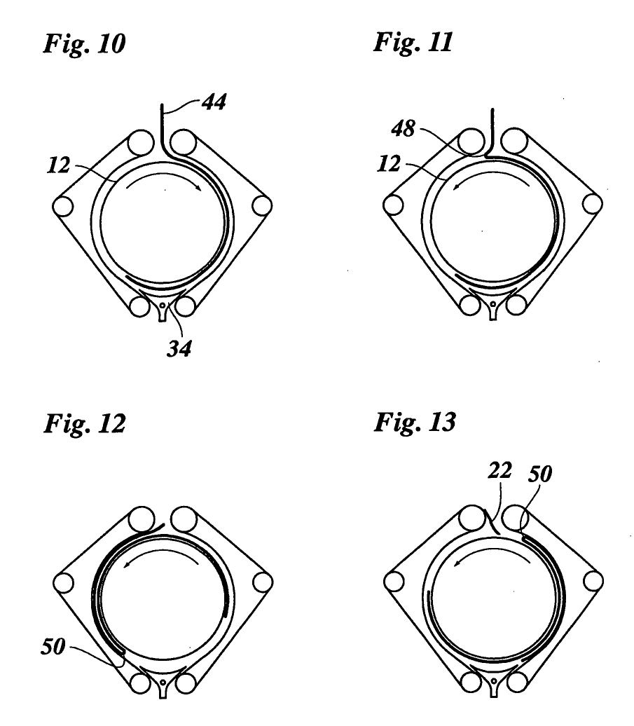

If the sheet is to be discharged in reverse orientation, with the fold 50 at the trailing end, the step that has been illustrated in FIG. 7 is replaced by the steps shown in FIGS. 8 and 9. In FIG. 8, the gate 34 has been opened so as to deflect the sheet into the path on the right side of the drum 12. Then, when the trailing end of the sheet has passed the gate 34, the direction of rotation of the drum 12 is reversed again and the gate 34 is closed, so that the sheet is discharged with the “open” end 54 ahead.

Another mode of operation, for forming a C-fold in a sheet, will now be explained in conjunction with FIGS. 10 through 16. In FIG. 10, the drum 12 is driven clock-wise, and the sheet 44 is supplied until the leading end has passed beyond the gate 34. Then, as shown in FIG. 11, the drum is reversed to form the blouse 48. Continued anti-clockwise rotation of the drum 12 produces a first fold 50, as shown in FIG. 12. The drum 12 is rotated further, so that the fold 50 passes the gate 34 and approaches again the pinch rollers 26 on the top of the drum 12, as shown in FIG. 13. Meanwhile, the deflection finger 22 has been brought into the operative position.

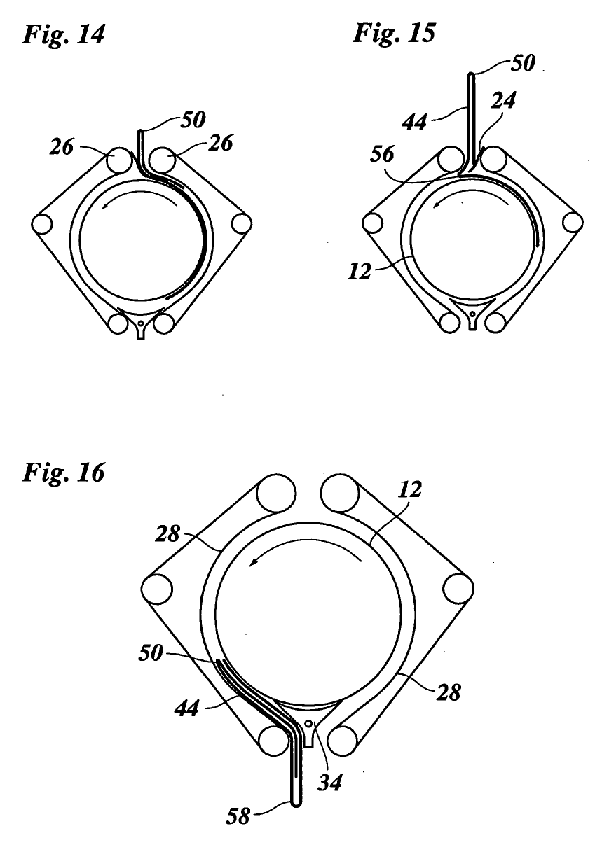

Then, as shown in FIG. 14, the fold 50 reaches the deflection finger 22 and is deflected upwardly so as to exit between the pinch rollers 26. In the situation shown in FIG. 15, the double-layered part of the sheet 44 has left the surface of the drum 12 and has passed through the gap between the pinch rollers 26. Then, the deflection finger 22 is withdrawn and the deflection finger 24 is brought into position, instead. The drum 12 continues to rotate counter clock-wise. As a result, another blouse 56 is formed in the single-layered part of the sheet.

The blouse 56 is then pinched between the pinch roller 26 and the belt 28 on the one hand and the surface of the drum 12 on the other hand, so that a second fold 58 is formed, as has been illustrated in FIG. 16. Thus, the sheet 44 now has a C-folded configuration.

In the example shown in FIG. 16, the gate 34 has been closed so as to discharge the sheet 44 with the fold 58 ahead. Of course, it would also have been possible to open the gate 34 and reverse the direction of rotation of the drum 12 once again so as to discharge the sheet with the fold 50 ahead, as previously explained in conjunction with FIGS. 8 and 9.

When handling multi-layer sheets such as the sheet 44 in FIG. 16, it is a particular advantage of the present invention that the belts 28 can be driven to move with the same speed as the surface of the drum 12, so that the folded package of the sheet 44 is not subject to any shear stresses.

It will be understood that a plurality of different folding patterns can be formed simply by suitably controlling the timings at which the rotation of the drum 12 is reversed and at which the deflection fingers 22, 24 and the gate 34 are operated.

In the apparatus that has been described above, the belts 28 are deflected at their top ends by the pinch rollers 26 which may be supported in such a manner that they are elastically biased against the surface of the drum 12 so as to exert a suitable pinching pressure onto the sheet so as to form the folds therein. In a modified embodiment, however, the positions of the pinch rollers 26 in FIG. 1 may be occupied by deflection rollers that are separated from the surface of the drum similarly as the deflection rollers 32 in FIG. 1. Then, the belts 28 would tangentially approach the surface of the drum 12, so that the leading edge of a sheet can smoothly be guided into the gap between the belt and the drum surface. Pinch rollers may then be provided offset from the top deflection rollers at the portion 28a of the belt.

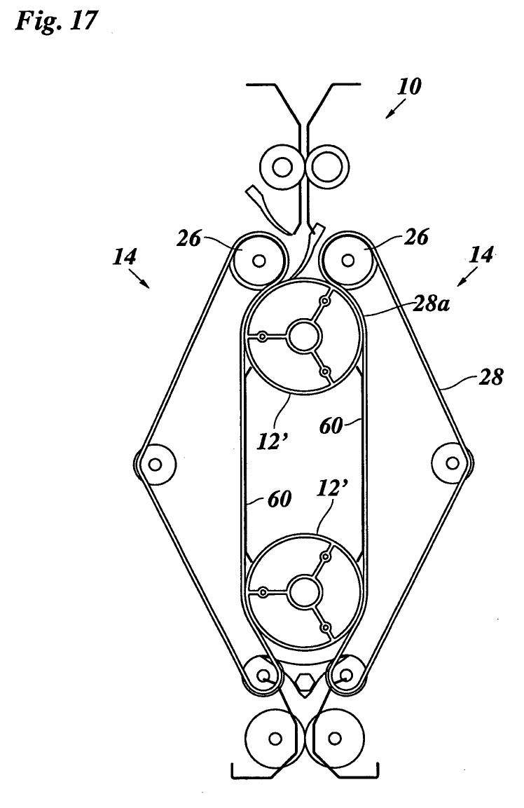

FIG. 17 illustrates another embodiment of the present invention, wherein the folding substrate is formed by two separate smaller drums 12′ that are arranged in parallel and are connected by stationary guides 60 which, together with the belts 28, define a closed circulation path for the sheets. Here, the belts 28 have straight portions running along the guides 60 without pressing against these guides or pressing only moderately there against, so that the sheets or sheet portions, when passing along the guide 60, will not experience any substantial friction or shearing strains.

In a modified embodiment (not shown), however, friction may be reduced further by training an endless belt around the two drums 12′, so that this belt will then form the folding substrate. Optionally, this belt may be backed by stationary guides comparable to the guides 60 in FIG. 17.

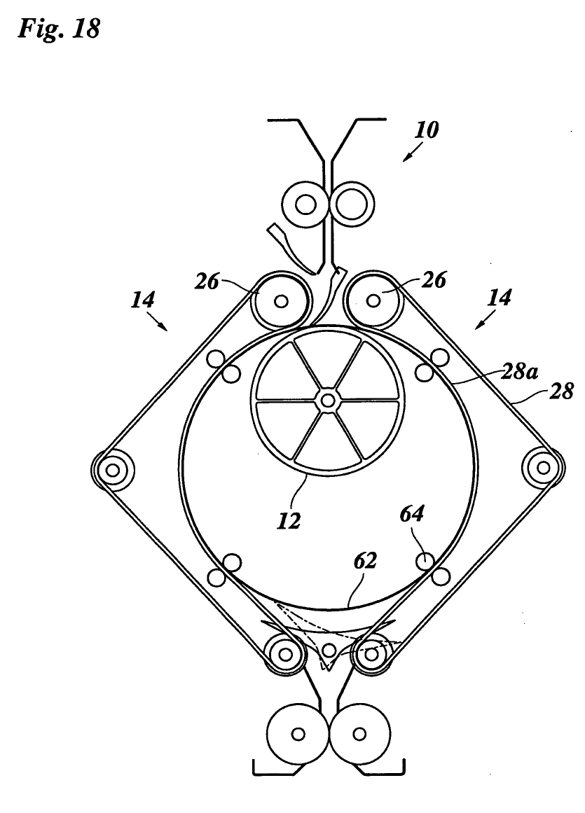

FIG. 18 shows another embodiment wherein the folding substrate is formed by a relatively small drum 12 and a larger endless belt 62 that is supported by the drum 12 and by a number of pairs of support rollers 64. The belt 62 may be made of a semi-rigid material so that it can be held in a defined, e.g. circular shape with only a few support rollers 64. The pinch rollers 26 engage the belt 62 at positions where this belt is directly supported by the drum 12, so that a sufficient pinching pressure can be exerted.

The embodiments discussed in conjunction with FIGS. 17 and 18 are particularly useful for handling large-format sheets, because they provide a comparatively long circulation path for the sheets while, on the other hand, the mass of inertia or moment of inertia of the members that have to be moved alternatingly in opposite directions can be kept relatively small.

All embodiments have the advantage that the belts 28 keep the sheets or the folded packets close to the surface of the folding substrate and smoothly guide the same, especially when they are moved synchronously with the folding substrate. Since the sheet or packet is suitably pressed against the surface of the folding substrate on almost the entire length of its path, it is successfully prevented from sliding sideways in the apparatus.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A folding apparatus, comprising:
a feed unit for supplying a medium to be folded;
a folding substrate forming a convexly curved support surface for the medium and adapted to be driven back and forth in a circumferential direction of said curved support surface; and
a pinch and guide structure for folding and guiding the medium on the support surface, said pinch and guide structure comprising two endless belts, each of the two endless belts being arranged to have a belt portion held in mating engagement with a portion of the curved support surface, so that the two endless belts define two separate paths for the medium,
wherein the folding substrate and the pinch and guide structure define a closed circulation path, in which the two separate paths are joined at a point remote from the feed unit.

2. The folding apparatus according to claim 1, wherein the folding substrate is a cylindrical drum.

3. The folding apparatus according to claim 1, wherein the folding substrate comprises a plurality of drums interconnected by stationary guides.

4. The folding apparatus according to claim 1, wherein the folding substrate comprises an endless belt.

5. The folding apparatus according to claim 1, wherein at least one of the two endless belts is adapted to be driven synchronously with the folding substrate.

6. The folding apparatus according to claim 1, wherein the pinch and guide structure comprises a pinch roller biasing each of said two endless belts against the folding substrate.

7. The folding apparatus according to claim 1, wherein there are a pair of said pinch and guide structures arranged mirror-symmetrically with respect to the folding substrate.
